(19) United States
(12) Patent Application Publication
(10) Pub. No.: US 2020/0167743 A1
(43) Pub. Date: May 28, 2020

(54) PAYMENT SYSTEM AND METHOD

(71) Applicants: William Ford Dolphin, Los Angeles, CA (US); Damian Sarkiss Stuart Hagge, Scottsdale, AZ (US)

(72) Inventors: William Ford Dolphin, Los Angeles, CA (US); Damian Sarkiss Stuart Hagge, Scottsdale, AZ (US)

(21) Appl. No.: 16/696,686

(22) Filed: Nov. 26, 2019

Related U.S. Application Data
(60) Provisional application No. 62/771,395, filed on Nov. 26, 2018.

(51) Int. Cl. G06Q 20/10; G06Q 20/32

(52) U.S. Cl. CPC G06Q 20/102; G06Q 20/24; G06Q 20/3255

(57) ABSTRACT

A computer-implemented method, computer program product and computing system for obtaining information concerning an outstanding payment related to medical services; providing an electronic notification to a related party concerning the outstanding payment; and enabling the related party to effectuate electronic settlement of at least a portion of the outstanding payment without having to establish an account.

### RELATED APPLICATION(S)

This application claims the benefit of U.S. Provisional Application No. 62/771,395, filed on 26 Nov. 2018, the entire contents of which are incorporated herein by reference.

### TECHNICAL FIELD

This disclosure relates to payment systems and, more particularly, to text message based payment systems.

### BACKGROUND

In many applications (such as health care billing), current billing practices rely on the generation of paper bills by the provider (e.g., a physician, a therapist, a nurse, a healthcare professional, or third-party service contracted to provide such billing services), which are provided to the recipient (e.g., the patient, the payer or the customer) via the postal service.

Upon receiving this paper bill, the recipient receiving this bill may take one of several actions, examples of which may include but are not limited to: (i) returning the bill to the provider by mail with an enclosed bank check, credit or debit card information or other means to make payment; (ii) verbally conveying credit or debit card information to the provider via telephone or electronic communication; or (iii) logging into a provider's website (requiring a password) and making payment by providing debit, credit or other approved payment cards or bank account.

Unfortunately, such paper bills may be lost in the mail or may be misplaced after being received by the recipient, resulting in the provider never getting paid.

### SUMMARY OF DISCLOSURE

A computer-implemented method is executed on a computing device and includes: obtaining information concerning an outstanding payment related to medical services; providing an electronic notification to a related party concerning the outstanding payment; and enabling the related party to review details of the outstanding payment and effectuate electronic settlement of at least a portion of the outstanding payment without having to establish an account.

One or more of the following features may be included. Obtaining information concerning an outstanding payment related to medical services may include periodically updating the information concerning an outstanding payment related to medical services. Obtaining information concerning an outstanding payment related to medical services may include obtaining information concerning an outstanding payment related to medical services from an accounts receivable system. Providing an electronic notification to a related party concerning the outstanding payment may include: generating a text message for the related party concerning the outstanding payment; and providing the text message to the related party via a text-messaging system. Providing an electronic notification to a related party concerning the outstanding payment may include providing a plurality of temporally-spaced electronic notifications to the related party concerning the outstanding payment, wherein later-transmitted electronic notifications within the plurality of temporally-spaced electronic notifications may be modified to include supplemental information. Enabling the related party to review details of the outstanding payment and effectuate electronic settlement of at least a portion of the outstanding payment without having to establish an account may include enabling the related party to define electronic payment information that is used to effectuate electronic settlement of at least a portion of the outstanding payment. The electronic payment information may include one or more of: credit card information; bank account information; and electronic wallet information. Enabling the related party to review details of the outstanding payment and effectuate electronic settlement of at least a portion of the outstanding payment without having to establish an account further may include storing the electronic payment information for future use. Enabling the related party to review details of the outstanding payment and effectuate electronic settlement of at least a portion of the outstanding payment without having to establish an account further may include launching a web application to enable the related party to effectuate electronic settlement of at least a portion of the outstanding payment without having to establish an account. One or more reports may be generated concerning the electronic settlement of the at least a portion of the outstanding payment. The one or more reports may be provided to a third party. The information concerning the outstanding payment may concern an amount unpaid by a medical insurance company.

In another implementation, a computer program product resides on a computer readable medium and has a plurality of instructions stored on it. When executed by a processor, the instructions cause the processor to perform operations including: obtaining information concerning an outstanding payment related to medical services; providing an electronic notification to a related party concerning the outstanding payment; and enabling the related party to review details of the outstanding payment and effectuate electronic settlement of at least a portion of the outstanding payment without having to establish an account.

One or more of the following features may be included. Obtaining information concerning an outstanding payment related to medical services may include periodically updating the information concerning an outstanding payment related to medical services. Obtaining information concerning an outstanding payment related to medical services may include obtaining information concerning an outstanding payment related to medical services from an accounts receivable system. Providing an electronic notification to a related party concerning the outstanding payment may include: generating a text message for the related party concerning the outstanding payment; and providing the text message to the related party via a text-messaging system. Providing an electronic notification to a related party concerning the outstanding payment may include providing a plurality of temporally-spaced electronic notifications to the related party concerning the outstanding payment, wherein later-transmitted electronic notifications within the plurality of temporally-spaced electronic notifications may be modified to include supplemental information. Enabling the related party to review details of the outstanding payment and effectuate electronic settlement of at least a portion of the outstanding payment without having to establish an account may include enabling the related party to define electronic payment information that is used to effectuate electronic settlement of at least a portion of the outstanding payment. The electronic payment information may include one or more of: credit card information; bank account information; and electronic wallet information. Enabling the related party to review details of the outstanding payment and effectuate electronic settlement of at least a portion of the outstanding payment without having to establish an account further may include storing the electronic payment information for future use. Enabling the related party to review details of the outstanding payment and effectuate electronic settlement of at least a portion of the outstanding payment without having to establish an account further may include launching a web application to enable the related party to effectuate electronic settlement of at least a portion of the outstanding payment without having to establish an account. One or more reports may be generated concerning the electronic settlement of the at least a portion of the outstanding payment. The one or more reports may be provided to a third party. The information concerning the outstanding payment may concern an amount unpaid by a medical insurance company.

In another implementation, a computing system includes a processor and memory is configured to perform operations including: obtaining information concerning an outstanding payment related to medical services; providing an electronic notification to a related party concerning the outstanding payment; and enabling the related party to review details of the outstanding payment and effectuate electronic settlement of at least a portion of the outstanding payment without having to establish an account.

One or more of the following features may be included. Obtaining information concerning an outstanding payment related to medical services may include periodically updating the information concerning an outstanding payment related to medical services. Obtaining information concerning an outstanding payment related to medical services may include obtaining information concerning an outstanding payment related to medical services from an accounts receivable system. Providing an electronic notification to a related party concerning the outstanding payment may include: generating a text message for the related party concerning the outstanding payment; and providing the text message to the related party via a text-messaging system. Providing an electronic notification to a related party concerning the outstanding payment may include providing a plurality of temporally-spaced electronic notifications to the related party concerning the outstanding payment, wherein later-transmitted electronic notifications within the plurality of temporally-spaced electronic notifications may be modified to include supplemental information. Enabling the related party to review details of the outstanding payment and effectuate electronic settlement of at least a portion of the outstanding payment without having to establish an account may include enabling the related party to define electronic payment information that is used to effectuate electronic settlement of at least a portion of the outstanding payment. The electronic payment information may include one or more of: credit card information; bank account information; and electronic wallet information. Enabling the related party to review details of the outstanding payment and effectuate electronic settlement of at least a portion of the outstanding payment without having to establish an account further may include storing the electronic payment information for future use. Enabling the related party to review details of the outstanding payment and effectuate electronic settlement of at least a portion of the outstanding payment without having to establish an account further may include launching a web application to enable the related party to effectuate electronic settlement of at least a portion of the outstanding payment without having to establish an account. One or more reports may be generated concerning the electronic settlement of the at least a portion of the outstanding payment. The one or more reports may be provided to a third party. The information concerning the outstanding payment may concern an amount unpaid by a medical insurance company.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a payment process according to an embodiment of the present disclosure; and

FIG. 2 is a flowchart of an implementation of the payment process of FIG. 1 according to an embodiment of the present disclosure.

Like reference symbols in the various drawings indicate like elements.

### DETAILED DESCRIPTION OF THE PREFERRED EMBODIMENTS

System Overview

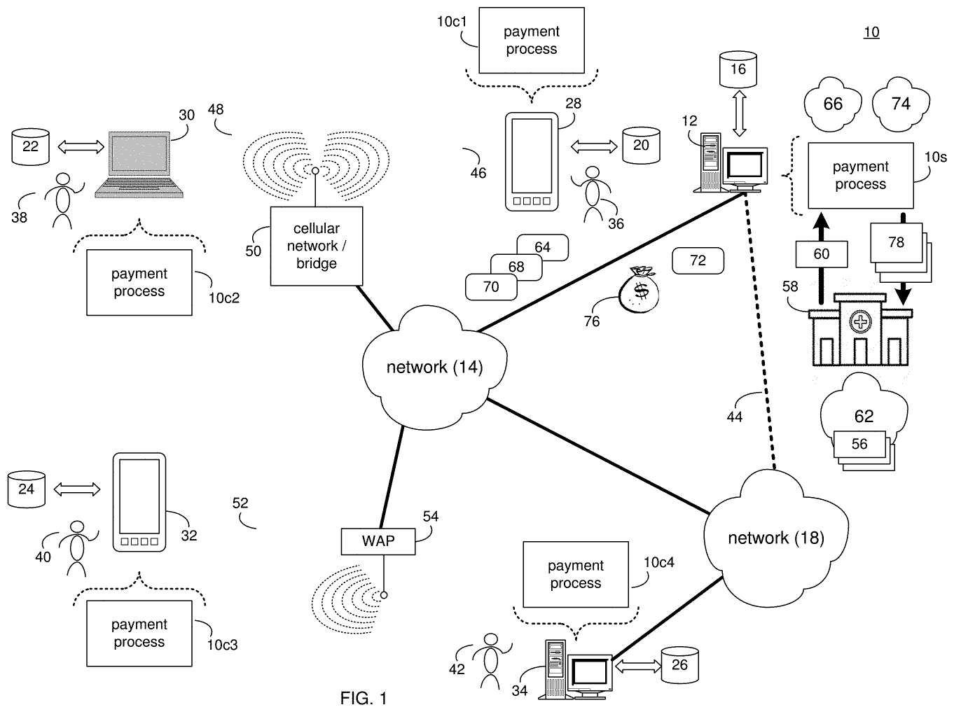

Referring to FIG. 1, there is shown payment process 10. Payment process 10 may be implemented as a server-side process, a client-side process, or a hybrid server-side/client-side process. For example, payment process 10 may be implemented as a purely server-side process via payment process 10s. Alternatively, payment process 10 may be implemented as a purely client-side process via one or more of payment process 10c1, payment process 10c2, payment process 10c3, and payment process 10c4. Alternatively still, payment process 10 may be implemented as a hybrid server-side/client-side process via payment process 10s in combination with one or more of payment process 10c1, payment process 10c2, payment process 10c3, and payment process 10c4. Accordingly, payment process 10 as used in this disclosure may include any combination of payment process 10s, payment process 10c1, payment process 10c2, payment process, and payment process 10c4.

Payment process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of payment process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of payment processes 10c1, 10c2, 10c3, 10c4 may include but are not limited to a client application, a web browser, a game console user interface, or a specialized application (e.g., an application running on e.g., the Android® platform or the iOS® platform). The instruction sets and subroutines of payment processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows®, Android®, WebOS®, iOS®, Redhat Linux®, or a custom operating system.

Users 36, 38, 40, 42 may access payment process 10 directly through network 14 or through secondary network 18. Further, payment process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Payment Process

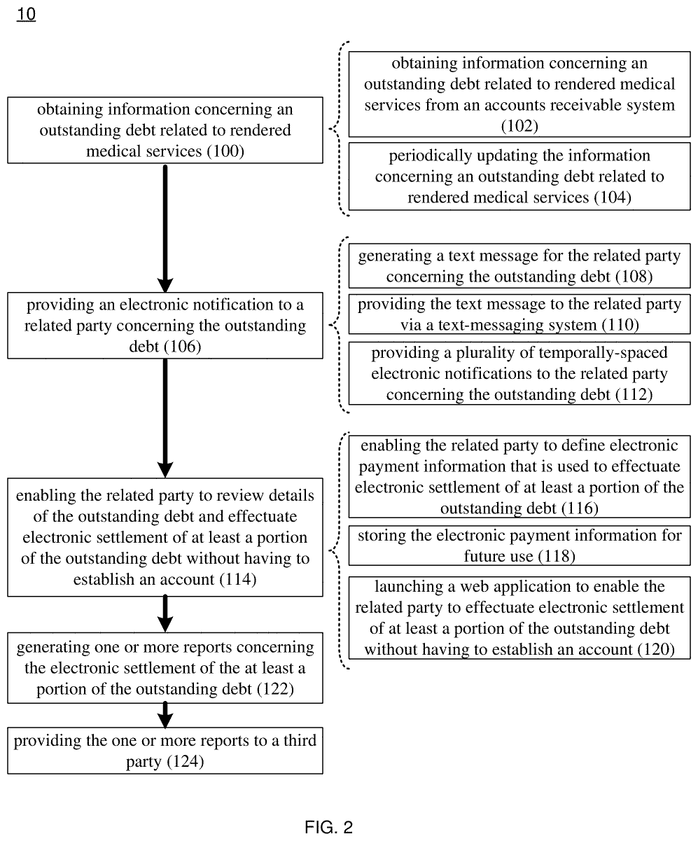

Referring also to FIG. 2 and as will be discussed below in greater detail, payment process 10 may be configured to effectuate the settlement of an outstanding payment (e.g., invoices 56) that may be related to medical services. An example of these medical services may include but are not limited to medical services that were previously rendered (e.g., during a previous visit to a medical facility (e.g., medical facility 58), examples of which may include but are not limited to a doctor's office, a medical practice, a clinic, a hospital, and a pharmacy). Another example of these medical services may include but are not limited to medical services that will be rendered in the future (e.g., an upcoming MRI procedure at medical facility 58). Another example of these medical services may include but are not limited to medical insurance services (e.g., such as the payment of an upcoming or past due medical insurance premium). As will be discussed below in greater detail, the settlement of invoices 56 may be accomplished electronically in a simple and efficient manner via payment process 10.

For example, assume that user 36 was at medical facility 58 (e.g., a hospital) for a minor surgery. Further assume that for various reasons, certain payments (e.g., invoices 56) are outstanding with respect to user 36. Some portion of this outstanding payment (e.g., invoices 56) may concern an amount unpaid by a medical insurance company. Other portions of this outstanding payment (e.g., invoices 56) may concern an amount unpaid by user 36.

Payment process 10 may obtain 100 information 60 concerning this outstanding payment (e.g., invoices 56) related to these medical services (e.g., the minor surgery). When obtaining 100 information 60 concerning the outstanding payment (e.g., invoices 56) related to rendered medical services (e.g., the minor surgery), payment process 10 may obtain 102 information 60 concerning the outstanding payment (e.g., invoices 56) related to the rendered medical services (e.g., the minor surgery) from an accounts receivable system (e.g., accounts receivable system 62). Examples of accounts receivable system 62 may include but are not limited to an accounts receivable system that is proprietary to (included within) medical facility 58 (e.g., an internal billing and collections system) and/or an accounts receivable system that is external to medical facility 58 (e.g., a third party billing and collections system).

Further and when obtaining 100 information 60 concerning the outstanding payment (e.g., invoices 56) related to the rendered medical services (e.g., the minor surgery), payment process 10 may periodically update 104 information 60 concerning the outstanding payment (e.g., invoices 56) related to the rendered medical services (e.g., the minor surgery). For example, payment process 10 may periodically (e.g., hourly, daily, weekly, monthly) update 104 information 60 by obtaining 100 an updated version of information 60 concerning the outstanding payment (e.g., invoices 56) related to the rendered medical services (e.g., the minor surgery) to ensure that e.g., a payment that is currently listed as being outstanding was not settled the previous week by e.g., user 36.

Once information 60 is obtained 100, payment process 10 may provide 106 an electronic notification (e.g., electronic notification 64) to a related party (e.g., user 36, a guardian of user 36, an employer of user 36, or a third party related to user 36) concerning the outstanding payment (e.g., invoices 56). For example and when providing 106 an electronic notification (e.g., electronic notification 64) to a related party (e.g., user 36, a guardian of user 36, an employer of user 36, or a third party related to user 36) concerning the outstanding payment (e.g., invoices 56), payment process 10 may generate 108 a text message (e.g., electronic notification 64) for the related party (e.g., user 36, a guardian of user 36, an employer of user 36, or a third party related to user 36) concerning the outstanding payment (e.g., invoices 56) and may provide 110 the text message (e.g., electronic notification 64) to the related party (e.g., user 36, a guardian of user 36, an employer of user 36, or a third party related to user 36) via a text-messaging system (e.g., text-messaging system 66).

When providing 106 an electronic notification (e.g., electronic notification 64) to a related party (e.g., user 36, a guardian of user 36, an employer of user 36, or a third party related to user 36) concerning the outstanding payment (e.g., invoices 56), payment process 10 may provide 112 a plurality of temporally-spaced electronic notifications (e.g., electronic notifications 64, 68, 70) to the related party (e.g., user 36, a guardian of user 36, an employer of user 36, or a third party related to user 36) concerning the outstanding payment (e.g., invoices 56), wherein later-transmitted electronic notifications within the plurality of temporally-spaced electronic notifications may be modified to include supplemental information. For example, payment process 10: may provide 112 electronic notification 64 concerning invoices 56 on Day 0; may provide 112 electronic notification 68 concerning invoices 56 on Day 7; may provide 112 electronic notification 70 concerning invoices 56 on Day 14; and so on. Specifically, payment process 10 may generate four copies of the electronic notification (e.g., electronic notification 64 for providing to the related party on Day 0; electronic notification 68 for providing to the related party on Day 7; and electronic notification 70 for providing to the related party on Day 14). While electronic notification 64 (the Day 0 copy) may include just basic information (e.g., You have an outstanding invoice for $100 to Dr. Smith for a dental extraction), later-transmitted electronic notifications 68, 70 may be modified to include supplemental information. For example, electronic notification 68 may be modified to include supplemental information designed to entice payment (e.g., “We understand that current economic conditions may make it difficult to stay current on your bills. Accordingly and since you are a longstanding patient of Dr. Smith, we can offer you a 15% discount if you settle your account within the next 24 hours). Further, electronic notification 68 may be modified to include supplemental information designed to threaten collections (e.g., “We understand that current economic conditions may make it difficult to stay current on your bills. But since you have failed to acknowledge any of our previous messages, we will be forced to send your account to collections if you do not settle your account within the next 24 hours). This supplemental information may be defined/determined in various ways. For example, payment process 10 may follow one or more rules that define e.g., when to offer a discount, the amount of the discount offered, and when to threaten to send someone to collections. Additionally/alternatively, payment process 10 may utilize machine learning/artificial intelligence to identify e.g., when to offer a discount, the amount of the discount offered, and when to threaten to send someone to collections.

Payment process 10 may enable 114 the related party (e.g., user 36, a guardian of user 36, an employer of user 36, or a third party related to user 36) to review details of the outstanding payment and effectuate electronic settlement of at least a portion of the outstanding payment (e.g., invoices 56) without having to establish an account. Accordingly and unlike systems that may require the user (e.g., user 36, a guardian of user 36, an employer of user 36, or a third party related to user 36) to establish an account (e.g., by defining a user name, a password, a physical address, an email address, etc.), payment process 10 may enable 114 the related party to review details of the outstanding payment and determine that e.g., the outstanding payment concerns the above-mentioned minor surgery that was performed by Dr. Smith. Payment process 10 may further enable 114 the related party to quickly and simply settle all or a portion of invoices 56 (as will be explained below).

When enabling 114 the related party (e.g., user 36, a guardian of user 36, an employer of user 36, or a third party related to user 36) to review details of the outstanding payment and effectuate electronic settlement of at least a portion of the outstanding payment (e.g., invoices 56) without having to establish an account, payment process 10 may enable 116 the related party (e.g., user 36, a guardian of user 36, an employer of user 36, or a third party related to user 36) to define electronic payment information (e.g., electronic payment information 72) that is used to effectuate electronic settlement of at least a portion of the outstanding payment (e.g., invoices 56). Examples of this electronic payment information (e.g., electronic payment information 72) may include but are not limited to one or more of: credit card information (e.g., a credit card number, an expiration date, and a CVC code); bank account information (e.g., an account number and a routing number); and electronic wallet information (e.g., information required to access payment methodologies defined within ApplePay® and GooglePay®.

When enabling 114 the related party (e.g., user 36, a guardian of user 36, an employer of user 36, or a third party related to user 36) to review details of the outstanding payment and effectuate electronic settlement of at least a portion of the outstanding payment (e.g., invoices 56) without having to establish an account, payment process 10 may store 118 the electronic payment information (e.g., electronic payment information 72) for future use (e.g., to settle future outstanding invoices, not shown). Further and when enabling 114 the related party (e.g., user 36, a guardian of user 36, an employer of user 36, or a third party related to user 36) to review details of the outstanding payment and effectuate electronic settlement of at least a portion of the outstanding payment (e.g., invoices 56) without having to establish an account, payment process 10 may launch 120 a web application (e.g., web application 74) to enable the related party (e.g., user 36, a guardian of user 36, an employer of user 36, or a third party related to user 36) to effectuate electronic settlement of at least a portion of the outstanding payment (e.g., invoices 56) without having to establish an account.

For example, assume that the outstanding payment (e.g., invoices 56) of user 36 concerns a medical insurance short pay, wherein a medical insurance company paid $100 less than what medical facility 58 charged user 36 for the related medical services (e.g., the minor surgery). Accordingly, medical facility 58 may bill user 36 for this outstanding payment (e.g., invoices 56) of $100. Therefore, payment process 10 may obtain 100 information 60 concerning this outstanding payment (e.g., invoices 56) related to these rendered medical services (e.g., the minor surgery). Payment process 10 may then provide 106 electronic notification 64 (e.g., a text message) to the related party (e.g., user 36, a guardian of user 36, an employer of user 36, or a third party related to user 36). As discussed above, payment process 10 may enable 114 the related party (e.g., user 36, a guardian of user 36, an employer of user 36, or a third party related to user 36) to review details of the outstanding payment and effectuate electronic settlement of at least a portion of the outstanding payment (e.g., invoices 56) without having to establish an account. Specifically, electronic notification 64 (e.g., a text message) may be received upon data-enabled, cellular telephone 28 of user 36, wherein electronic notification 64 (e.g., a text message) may include a link that when selected may launch 120 web application 74 to enable the related party (e.g., user 36, a guardian of user 36, an employer of user 36, or a third party related to user 36) to settle all or a portion of the outstanding payment (e.g., invoices 56).

For example, web application 74 may enable 116 the related party (e.g., user 36, a guardian of user 36, an employer of user 36, or a third party related to user 36) to define electronic payment information 72, examples of which may include but are not limited to: credit card information (e.g., a credit card number, an expiration date, and a CVC code); bank account information (e.g., an account number and a routing number); and electronic wallet information (e.g., information required to access payment methodologies defined within ApplePay® and GooglePay®). Once defined, electronic payment information 72 may be used by the related party (e.g., user 36, a guardian of user 36, an employer of user 36, or a third party related to user 36) to effectuate electronic settlement of at least a portion of the outstanding payment (e.g., invoices 56) without having to establish an account. For example, the related party (e.g., user 36, a guardian of user 36, an employer of user 36, or a third party related to user 36) may utilize credit card information, bank account information, and/or electronic wallet information to settle all (e.g., $100) or a portion (e.g., $50) of the outstanding payment (e.g., invoices 56), wherein any funds (e.g., funds 76) provided by the related party (e.g., user 36, a guardian of user 36, an employer of user 36, or a third party related to user 36) may be provided to e.g., medical facility 58. Additionally, payment process 10 may generate 122 one or more reports (e.g., reports 78) concerning the electronic settlement of the at least a portion of the outstanding payment; and may provide 124 the one or more reports (e.g., reports 78) to a third party (e.g., medical facility 58).

Reports 78 may define various pieces of information, examples of which may include but are not limited to: the number of electronic notifications sent out, the number of invoices paid, the identity of the paying entities, the identity of the non-paying entities, the fees owed by medical facility 58 for the use of payment process 10, the average payment time for the paying entities, the total invoices collected from the paying entities, the total outstanding invoices for the non-paying entities, the total fees paid by medical facility 58 for the use of payment process 10, etc.)

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
obtaining information concerning an outstanding payment related to medical services;
providing an electronic notification to a related party concerning the outstanding payment; and
enabling the related party to review details of the outstanding payment and effectuate electronic settlement of at least a portion of the outstanding payment without having to establish an account.

2. The computer-implemented method of claim 1 wherein obtaining information concerning an outstanding payment related to medical services includes:
periodically updating the information concerning an outstanding payment related to medical services.

3. The computer-implemented method of claim 1 wherein obtaining information concerning an outstanding payment related to medical services includes:
obtaining information concerning an outstanding payment related to medical services from an accounts receivable system.

4. The computer-implemented method of claim 1 wherein providing an electronic notification to a related party concerning the outstanding payment includes:
generating a text message for the related party concerning the outstanding payment; and
providing the text message to the related party via a text-messaging system.

5. The computer-implemented method of claim 1 wherein providing an electronic notification to a related party concerning the outstanding payment includes:
providing a plurality of temporally-spaced electronic notifications to the related party concerning the outstanding payment, wherein later-transmitted electronic notifications within the plurality of temporally-spaced electronic notifications are modified to include supplemental information.

6. The computer-implemented method of claim 1 wherein enabling the related party to review details of the outstanding payment and effectuate electronic settlement of at least a portion of the outstanding payment without having to establish an account includes:
enabling the related party to define electronic payment information that is used to effectuate electronic settlement of at least a portion of the outstanding payment.

7. The computer-implemented method of claim 6 wherein the electronic payment information includes one or more of:
credit card information;
bank account information; and
electronic wallet information.

8. The computer-implemented method of claim 6 wherein enabling the related party to review details of the outstanding payment and effectuate electronic settlement of at least a portion of the outstanding payment without having to establish an account further includes:
storing the electronic payment information for future use.

9. The computer-implemented method of claim 1 wherein enabling the related party to review details of the outstanding payment and effectuate electronic settlement of at least a portion of the outstanding payment without having to establish an account further includes:
launching a web application to enable the related party to effectuate electronic settlement of at least a portion of the outstanding payment without having to establish an account.

10. The computer-implemented method of claim 1 further comprising:
generating one or more reports concerning the electronic settlement of the at least a portion of the outstanding payment; and
providing the one or more reports to a third party.

11. The computer-implemented method of claim 1 wherein the information concerning the outstanding payment concerns an amount unpaid by a medical insurance company.

12. A computer program product residing on a non-transitory computer readable medium having a plurality of instructions stored thereon which, when executed by a processor, cause the processor to perform operations comprising:
obtaining information concerning an outstanding payment related to medical services;
providing an electronic notification to a related party concerning the outstanding payment; and
enabling the related party to review details of the outstanding payment and effectuate electronic settlement of at least a portion of the outstanding payment without having to establish an account.

13. The computer program product of claim 12 wherein obtaining information concerning an outstanding payment related to medical services includes:
periodically updating the information concerning an outstanding payment related to medical services.

14. The computer program product of claim 12 wherein obtaining information concerning an outstanding payment related to medical services includes:
obtaining information concerning an outstanding payment related to medical services from an accounts receivable system.

15. The computer program product of claim 12 wherein providing an electronic notification to a related party concerning the outstanding payment includes:
generating a text message for the related party concerning the outstanding payment; and
providing the text message to the related party via a text-messaging system.

16. The computer program product of claim 12 wherein providing an electronic notification to a related party concerning the outstanding payment includes:
providing a plurality of temporally-spaced electronic notifications to the related party concerning the outstanding payment, wherein later-transmitted electronic notifications within the plurality of temporally-spaced electronic notifications are modified to include supplemental information.

17. The computer program product of claim 12 wherein enabling the related party to review details of the outstanding payment and effectuate electronic settlement of at least a portion of the outstanding payment without having to establish an account includes:
enabling the related party to define electronic payment information that is used to effectuate electronic settlement of at least a portion of the outstanding payment.

18. The computer program product of claim 17 wherein the electronic payment information includes one or more of:
credit card information;
bank account information; and
electronic wallet information.

19. The computer program product of claim 17 wherein enabling the related party to review details of the outstanding payment and effectuate electronic settlement of at least a portion of the outstanding payment without having to establish an account further includes:
storing the electronic payment information for future use.

20. The computer program product of claim 12 wherein enabling the related party to review details of the outstanding payment and effectuate electronic settlement of at least a portion of the outstanding payment without having to establish an account further includes:
launching a web application to enable the related party to effectuate electronic settlement of at least a portion of the outstanding payment without having to establish an account.

21. The computer program product of claim 12 further comprising:
generating one or more reports concerning the electronic settlement of the at least a portion of the outstanding payment; and
providing the one or more reports to a third party.

22. The computer program product of claim 1 wherein the information concerning the outstanding payment concerns an amount unpaid by a medical insurance company.

23. A computing system including a processor and memory configured to perform operations comprising:
obtaining information concerning an outstanding payment related to medical services;
providing an electronic notification to a related party concerning the outstanding payment; and
enabling the related party to review details of the outstanding payment and effectuate electronic settlement of at least a portion of the outstanding payment without having to establish an account.

24. The computing system of claim 23 wherein obtaining information concerning an outstanding payment related to medical services includes:
periodically updating the information concerning an outstanding payment related to medical services.

25. The computing system of claim 23 wherein obtaining information concerning an outstanding payment related to medical services includes:
obtaining information concerning an outstanding payment related to medical services from an accounts receivable system.

26. The computing system of claim 23 wherein providing an electronic notification to a related party concerning the outstanding payment includes:
generating a text message for the related party concerning the outstanding payment; and
providing the text message to the related party via a text-messaging system.

27. The computing system of claim 23 wherein providing an electronic notification to a related party concerning the outstanding payment includes:
providing a plurality of temporally-spaced electronic notifications to the related party concerning the outstanding payment, wherein later-transmitted electronic notifications within the plurality of temporally-spaced electronic notifications are modified to include supplemental information.

28. The computing system of claim 23 wherein enabling the related party to review details of the outstanding payment and effectuate electronic settlement of at least a portion of the outstanding payment without having to establish an account includes:
enabling the related party to define electronic payment information that is used to effectuate electronic settlement of at least a portion of the outstanding payment.

29. The computing system of claim 28 wherein the electronic payment information includes one or more of:
credit card information;
bank account information; and
electronic wallet information.

30. The computing system of claim 28 wherein enabling the related party to review details of the outstanding payment and effectuate electronic settlement of at least a portion of the outstanding payment without having to establish an account further includes:
storing the electronic payment information for future use.

31. The computing system of claim 23 wherein enabling the related party to review details of the outstanding payment and effectuate electronic settlement of at least a portion of the outstanding payment without having to establish an account further includes:
launching a web application to enable the related party to effectuate electronic settlement of at least a portion of the outstanding payment without having to establish an account.

32. The computing system of claim 23 further comprising:
generating one or more reports concerning the electronic settlement of the at least a portion of the outstanding payment; and
providing the one or more reports to a third party.

33. The computing system of claim 23 wherein the information concerning the outstanding payment concerns an amount unpaid by a medical insurance company.
